(19) United States
(12) Patent Application Publication
(10) Pub. No.: US 2010/0213002 A1
(43) Pub. Date: Aug. 26, 2010

(54) FIBROUS MATERIALS, NOISE SUPPRESSION MATERIALS, AND METHODS OF MANUFACTURING NOISE SUPPRESSION MATERIALS

(75) Inventors: Reza Oboodi, Morris Plains, NJ (US); James Piascik, Randolph, NJ (US); Siu-ching D. Lui, Bridgewater, NJ (US); Martin Carlin Baker, Budd Lake, NJ (US); James F. Stevenson, Morristown, NJ (US)

Correspondence Address: HONEYWELL/IFL;Patent Services, 101 Columbia Road, P.O.Box 2245, Morristown, NJ, 07962-2245, US

(73) Assignee: Honeywell International Inc., Morristown, NJ (US)

(21) Appl. No.: 12/393,683

(22) Filed: Feb. 26, 2009

(51) Int. Cl. B32B 17/02; D02G 3/22; E04B 1/82; B32B 37/00

(52) U.S. Cl. 181/290; 428/371; 428/374; 156/60

(57) ABSTRACT

Noise suppression materials and methods of manufacturing noise suppression materials are provided. In an embodiment, by way of example only, a fibrous material includes a network of a plurality of fibers selected from a group consisting of glass fibers and ceramic fibers, the plurality of fibers including a first fiber and a second fiber, the first fiber having a first low melt component and a first high melt component, the first low melt component of the first fiber having a first melting point, the first high melt component of the first fiber having a second melting point that is higher than the first melting point, wherein the first low melt component of the first fiber extends alongside and is adjacent to at least a segment of the first high melt component of the first fiber and is bonded to the second fiber at a contact point.

### TECHNICAL FIELD

The inventive subject matter generally relates to noise suppression materials, and more particularly relates to noise suppression materials that may be employed as bulk absorbers and methods of manufacturing noise suppression materials.

### BACKGROUND

Many aircraft are powered by jet engines. In most instances, jet engines include one or more gas-powered turbine engines, auxiliary power units (APUs), and/or environmental control systems (ECSs), which can generate both thrust to propel the aircraft and electrical and pneumatic energy to power systems installed in the aircraft. Although most aircraft engines are generally safe, reliable, and efficient, the engines do exhibit certain drawbacks. For example, the turbine engines can be sources of unwanted noise, especially during aircraft take-off and landing operations. Moreover, APUs and ECSs can be sources of unwanted ramp noise while an aircraft is parked at the airport. Thus, various governmental and aircraft manufacturer rules and regulations aimed at mitigating such noise sources have been enacted.

To address the unwanted noise emanating from aircraft noise sources and to thereby comply with the above-noted rules and regulations, various types of noise reduction methods have been developed. For example, one noise reduction method that has been developed for use in aircraft ducts is a noise suppression panel. In many instances, noise suppression panels are flat or contoured, and include either a bulk noise suppression material or a honeycomb structure disposed between a backing plate and a face sheet. The noise suppression panels are typically placed on the interior surface of an engine or APU inlet and/or outlet ducts, as necessary, to reduce noise emanations.

Although the above-described noise suppression panels exhibit fairly good noise suppression characteristics, they may be improved. For example, the bulk absorber materials incorporated into noise suppression panels can be costly to manufacture. In some cases, the bulk absorber materials may not be suitable for incorporation into an exhaust section of the engine. In an example, conventional bulk absorber materials may have maximum operating temperatures that may limit usefulness to engine sections other than the exhaust section. Additionally, honeycomb structures that may be used in the noise suppression panels may be difficult to conform to contoured surfaces and can be difficult to bond to the backing plate and/or face plate. Moreover, when the honeycomb structure is combined with an inexpensive perforate face plate, the honeycomb structure may provide noise attenuation over only a relatively narrow frequency range.

Hence, there is a need for a noise suppression material that is less costly to manufacture as compared to known materials, and/or can be readily conformed to contoured surfaces, and/or can be readily bonded to backing and/or face sheets, and/or is effective over a relatively wide frequency range. Additionally, there is a need for materials that are capable of being employed in operating environments having temperatures in excess of about 371° C. (700° F.). The inventive subject matter addresses one or more of these needs.

### BRIEF SUMMARY

Noise suppression materials and methods of manufacturing noise suppression materials are provided.

In an embodiment, by way of example only, a fibrous material includes a network of a plurality of fibers selected from a group consisting of glass fibers and ceramic fibers, the plurality of fibers including a first fiber and a second fiber, the first fiber having a first low melt component and a first high melt component, the first low melt component of the first fiber having a first melting point, the first high melt component of the first fiber having a second melting point that is higher than the first melting point, wherein the first low melt component of the first fiber extends alongside and is adjacent to at least a segment of the first high melt component of the first fiber and is bonded to the second fiber at a contact point.

In another embodiment, by way of example only, a noise suppression material includes a face plate, a backing plate, and a fibrous mat disposed between the face plate and the backing plate. The fibrous mat comprises a network of a plurality of fibers selected from a group consisting of glass fibers and ceramic fibers, the plurality of fibers including a first fiber and a second fiber, the first fiber having a first low melt component and a first high melt component, the first low melt component of the first fiber having a first melting point, the first high melt component of the first fiber having a second melting point that is higher than the first melting point, wherein the first low melt component of the first fiber extends alongside and is adjacent to at least a segment of the first high melt component of the first fiber and is bonded to the second fiber at a contact point.

In still another embodiment, by way of example only, a method of manufacturing a noise suppression material includes heat treating a plurality of fibers to a first temperature, the plurality of fibers selected from a group consisting of glass fibers and ceramic fibers, the plurality of fibers including a first fiber and a second fiber, the first fiber capable of phase separation at the first temperature into a low melt phase and a high melt phase and bonding to itself or to the second fiber.

### BRIEF DESCRIPTION OF THE DRAWINGS

The inventive subject matter will hereinafter be described in conjunction with the following drawing figures, wherein like numerals denote like elements, and

FIG. 1 is a perspective, cutaway view of a noise suppression panel, according to an embodiment;

FIG. 2 is a cross-sectional, end view of fibers, according to an embodiment;

FIG. 3 is a cross-sectional, end view of a fiber, according to another embodiment; and

FIG. 4 is a method for manufacturing a noise suppression material, according to an embodiment.

### DETAILED DESCRIPTION

Before proceeding with the detailed description, it is to be appreciated that the described embodiments are not limited to use in conjunction with a particular type of engine, or in a particular type of vehicle. Thus, although the described embodiments are, for convenience of explanation, described as being implemented in an aircraft environment, it will be appreciated that the embodiments can be implemented in various other types of vehicles, and in various other systems and environments. Moreover, although the inventive subject matter is described as being implemented into a noise suppression panel, the inventive subject matter may be used alone or in combination with other structures to reduce noise. Moreover the inventive subject matter may be applied to any device using fibrous material and subject to high temperature, such as, for example a filter.

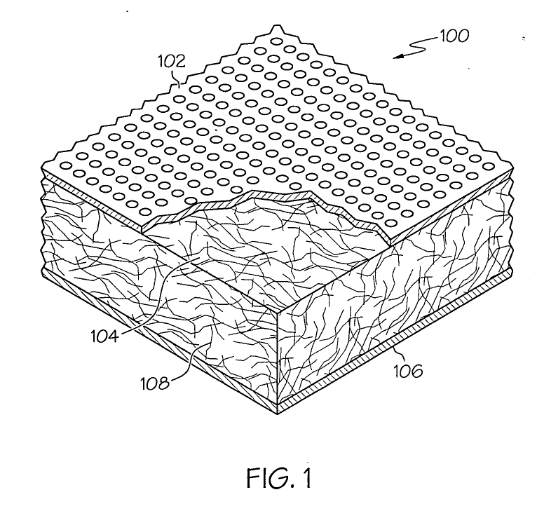

FIG. 1 is a perspective, cutaway view of a noise suppression panel 100, according to an embodiment. The noise suppression panel 100 is adapted to reduce an amount of noise that may travel from one area to another. According to an embodiment, the noise suppression panel 100 may be disposed in an aircraft to reduce noise that may emanate from an engine. For example, the noise suppression panel 100 may be placed in an aircraft duct, such as an air inlet plenum or an engine exhaust duct. Although the noise suppression panel 100 is shown as having a generally square shape, it may have any other shape suitable for placement into a designated area of the aircraft.

To suppress noise, the noise suppression panel 100 includes a face plate 102, a bulk absorber 104, and a backing plate 106, in an embodiment. The face plate 102 is configured to receive noise from a noise source, such as the engine, and to allow at least a portion of the noise to pass through. The face plate 102 may be further adapted to provide structure to the noise suppression panel 100. In this regard, the face plate 102 may be constructed of a material conventionally used for providing structure, such as stainless steel, bismaleimide (BMI) carbon fiber composites, and the like.

In an embodiment, to provide acoustic transparency, the face plate 102 is perforated to a desired percent open area value. As is used herein, the phrase “percent open area” (POA) may be defined as an amount of open area that allows passage of sound. In accordance with an embodiment, the face plate 102 is perforated to a POA of greater than 30%. For example, the POA may be in a range of from about 30% to about 50%, although the POA may be more or less. In other embodiments, the POA may be less than 30%.

Although the face plate 102 is shown as comprising a single layer of material, more than one layer of material may make up the face plate 102 in other embodiments. In any case, in accordance with an embodiment, the face plate 102 may have a total thickness in a range of from about 0.2 millimeters (mm) to about 0.8 mm. In other embodiments, the face plate 102 may be thicker or thinner than the aforementioned range.

The bulk absorber 104 is disposed between the face plate 102 and the backing plate 106 and is adapted to attenuate a majority of the noise passing through the face plate 102. In accordance with an embodiment, the bulk absorber may have a total thickness in a range of from about 25 mm to about 75 mm. In other embodiments, the bulk absorber 104 may be thicker or thinner than the aforementioned range.

According to an embodiment, the bulk absorber 104 comprises a fibrous material including a network of a plurality of fibers 108. As used herein, the term “network” may be defined as highly permeable material having fibers that cross each other at regular or irregular intervals. In an embodiment, the fibers are selected from glass materials or ceramic materials that allow the bulk absorber 104 to be exposed to temperatures that are greater than about 371° C. (700° F.) without degradation of physical integrity. In other embodiments, the glass or ceramic materials may be selected for having higher or lower temperature exposure capabilities. In still other embodiments, organic matter, such as phenolic resins, which could limit a maximum operating temperature of the bulk absorber 104, are omitted from the bulk absorber 104. In accordance with an embodiment, the bulk absorber 104 may have a fiber volume fraction (e.g., volume of fiber divided by volume of entire mat) in a range of from about 0.015 to about 0.055. In other embodiments, the density may be greater or less than the aforementioned range.

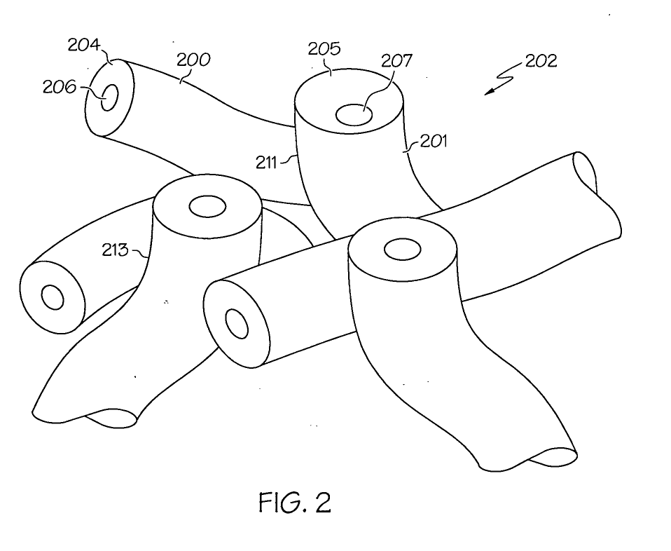

To form and maintain the structure of the network, at least a portion of the fibers includes different components. FIG. 2 is a cross-sectional view of a plurality of fibers 200, 201 comprising a bulk absorber 202, according to an embodiment. At least a portion of the fibers 200, 201 includes a low melt component 204, 205 and a high melt component 206, 207. As used herein, the term “low melt component” may be defined as a first segment or length of a fiber having a first melting point that is lower than a second melting point. The term “high melt component” may be defined as a second segment or length of the fiber having the second melting point. In an embodiment, substantially all of the fibers used in the bulk absorber 104 (FIG. 1) have low and high melt components. In other embodiments, a first portion of the fibers 200, 201 used in the bulk absorber 202 have low and high melt components 204, 205, 206, 207, and a second portion of the fibers 200, 201 do not have low and high melt components. In an example, the first portion may comprise more than 50% of the bulk absorber 202. In another example, the first portion may comprise less than 50% of the bulk absorber 202. In any case, the second portion of the fibers 200, 201 may comprise material that is formulated substantially similarly to the high melt component 206, 207, or another material that is not similar to either the low or high melt components 204, 205, 206, 207, but which has a melting point higher than the melting point of the low melt component.

In accordance with an embodiment, the plurality of fibers 200, 201 comprises a single type of glass material. For example, the material may be capable of being induced into separating into at least two phases, namely, a “low melt phase” and a “high melt phase.” As used herein, the term “low melt phase” may be defined as the phase with a low melting temperature. The term “high melt phase” may be defined as the phase with a high melting temperature. Thus, the low melt component 204, 205 may comprise the low melt phase of the fiber 200, 201, while the high melt component 206, 207 of the fiber 200, 201 comprises the high melt phase. Glass materials capable of phase separation include, but are not limited to borosilicate glasses. In other embodiments, other glass or ceramic materials may be employed. Alkali borosilicates (i.e. lithium borosilicate) or borate (B₂O₃) may be used as a flux to help initiate phase separation and sintering.

According to another embodiment, two or more materials comprise the plurality of glass fibers 200, 201. For example, one type of material capable of phase separation may be included to comprise the first portion of the plurality of fibers 200, 201, while one or more additional types of material that are incapable of phase separation may comprise the second portion of the plurality of fibers 200, 201. In another example, the two or more different types of materials, each capable of phase separation may comprise the plurality of fibers. In such case, the two or more different types of materials may be glass and ceramic materials, all glass materials, or all ceramic materials.

In still another example, two different types of materials may comprise the low and high melt components 204, 205, 206, 207 of the fibers 200, 201. Specifically, a first material may comprise the low melt component 204, 205 of the fiber 200, 201, and a second material may comprise the high melt component 206, 207 of the fiber 200, 201. In an embodiment, the first and second materials may be glass materials. In another embodiment, the first and second materials may be ceramic materials. In still another embodiment, the first material may be a glass or ceramic material, and the second material may be a ceramic material or vice versa. Glass materials suitable for use as the low melt component include, but are not limited to alkali borosilicates, and glass materials suitable for use as the high melt component include, but are not limited to silicates and borosilicates. Ceramic materials suitable for use as the high melt component include, but are not limited to alumina and zirconia. In other embodiments, other glass or ceramic materials may be employed. In yet another embodiment, a pair of different types of materials may comprise the low and high melt components 204, 205, 206, 207 of some of the fibers 200, 201, and one or more additional pairs of different types of materials may comprise the low and high melt components 204, 205, 206, 207 of other ones of the fibers 200, 201, and the low or high melt components 204, 205, 206, 207 may be different from each other. In another embodiment, the coefficient of thermal expansion of the low melt and high melt components 204, 205, 206, 207 may be different. For example, the low melt component 204, 205 may have a first coefficient of thermal expansion and the high melt component 206, 207 may have a second coefficient of thermal expansion that is different than the first coefficient of thermal expansion. In such case, the fibers 200, 201 may curl or spiral when heated to a temperature at which both the low and high melt components 204, 205, 206, 207 are at or above their respective softening temperatures. Such fiber configurations may facilitate entanglement within a fibrous mat.

In any case, the bulk absorber 202 may at least include, according to an embodiment, the plurality of fibers 200, 201 including at least a first fiber 200 and a second fiber 201, where each of the first and second fibers 200, 201 has corresponding low melt components 204, 205 and high melt components 206, 207. In one embodiment, the first fiber 200 has a first low melt component 204 and a first high melt component 206, the first low melt component 204 of the first fiber 200 has a first melting point, and the first high melt component 206 of the first fiber 200 has a second melting point that is higher than the first melting point. By employing glass and/or ceramic fibers that include low melt and high melt components, the low melt components bond with each other at contact points 211, 213 between the fibers when exposed to temperatures exceeding the first and/or third melting points, while the high melt components maintain their physical integrity at temperatures below the second and fourth melting points to provide the network structure suitable for use in the noise suppression material.

No matter the particular formulation of the materials used for the plurality of fibers 200, 201, each fiber having a low melt component and a high melt component may be configured such that the low melt component 204, 205 of the fiber 200, 201 extends along at least a segment of the first high melt component 206, 207 of the fiber 200, 201. A particular configuration of how the components are oriented relative to each other may depend on fiber manufacturing process. In an example, the low melt components 204, 205 of the fibers 200, 201 and the high melt components 206, 207 of the fiber 200, 201 may be disposed coaxially with respect to each other. For instance, a core of the high melt component 206, 207 may be at least partially or substantially surrounded by the low melt component 204, 205. According to an embodiment, the low melt component 204, 205 may be disposed concentric to the high melt component 206, 207. In another embodiment, the low melt component 204, 205 may be eccentric relative to the high melt component 206, 207.

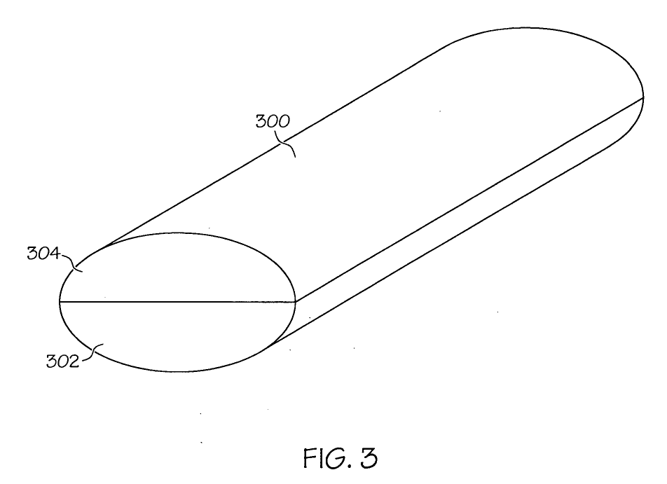

FIG. 3 is a cross-sectional, end view of a fiber 300, according to still another embodiment. Here, the fiber 300 has a low melt component 302 that extends in a side-by-side configuration relative to the high melt component 304. Thus, a length of the low melt component 302 and a corresponding length of the high melt component 304 extend adjacent to each other. In an embodiment, the length of the low melt component 302 and the corresponding length of the high melt component 304 extend parallel to each other.

In an embodiment, the fibers 200, 201, 300 may have particular cross-sectional shapes. For example, as illustrated in FIG. 2, the fibers (e.g., fibers 200) may have a round cross-sectional shape. In another embodiment, the fibers (e.g., fibers 201, 300) may have an ovular cross-sectional shape. In other embodiments, the fibers may have other cross-sectional shapes, such as square, rectangular, and the like. Moreover, the low and high melt components 204, 205, 206, 207, 302, 304 may have similar or different cross-sectional shapes. In an example, the low melt components may have round (e.g., low melt component 204) or ovular (e.g., low melt component 205) cross-sectional shapes, while the high melt components may have round (e.g., high melt components 206, 207), ovular, square, or other cross-sectional shapes. In another embodiment as shown in FIG. 3, the low and high melt components 302, 304 may each comprise one half, more than half or less than half of an overall cross-sectional shape of the fiber 300. For example, the low melt component 302 may comprise one half of an oval, while the high melt component 304 may comprise the other half of the oval.

Regardless of the particular cross-sectional shapes of the low and high melt components 204, 205, 206, 207, 302, 304, a largest diameter of the fibers 200, 201, 300 may be in a range of from about 10 micron to about 100 micron, in an embodiment. In another embodiment, the largest diameter may be greater or less than the aforementioned range. According to an embodiment in which the low melt component 204, 205 surrounds the circumference of the high melt component 206, 207 (FIG. 2), the low melt component 204, 205 may have a diameter in an range of from about 6 micron to about 100 microns, and the high melt component 206, 207 may have a diameter in a range of from about 6 micron to about 100 micron. In another embodiment, the diameters may be greater or less than the aforementioned ranges. In embodiments in which the low melt component 302 and the high melt component 304 are in a side-by-side configuration (FIG. 3), the low melt component 302 and the high melt component 304 may have substantially equal largest diameters. In other embodiments, the largest diameters may not be substantially equal, and the low melt component 302 may be larger than the high melt component 304 or the high melt component 304 may be larger than the low melt component 302. In any case, the low melt component 302 may have a largest diameter in a range of from about 10 micron to about 100 micron, and the high melt component 304 may have a largest diameter in a range of from about 10 micron to about 100 micron. In another embodiment, one or both of the largest diameters may be greater or less than the aforementioned ranges.

According to an embodiment, the fibers 200, 201, 300 may be extremely long, continuous fibers. For example, the fibers 200, 201, 300 may have lengths in a range of from about 5 mm to about 75 mm. In other embodiments, the lengths may be greater or less than the aforementioned range. In another embodiment, the fibers 200, 201, 300 may be relatively short fibers and may have lengths in a range of from about 1 mm cm to about 75 mm. In other embodiments, the lengths may be greater or less than the aforementioned range. In accordance with an embodiment, the fibers 200, 201, 300 may have uniform lengths. In other embodiments, the fibers 200, 201, 300 may have varied lengths.

Referring again to FIG. 1, the backing plate 106 is adapted to provide structure to the noise suppression panel 100 and is preferably imperforate and constructed from a non-porous material. In an embodiment, the backing plate 106 may include stainless steel. In another embodiment, the backing plate 106 may be constructed of a nickel based superalloy. In still other embodiments, the backing plate 106 may include other materials capable of providing structural support at high temperature. Additionally, although the backing plate 106 is shown as comprising a single layer of material, in other embodiments, more than one layer of material may make up the backing plate 106. In any case, in accordance with an embodiment, the backing plate 106 may have a total thickness in a range of from about 0.5 mm to about 4 mm. In other embodiments, the backing plate 106 may be thicker or thinner than the aforementioned range.

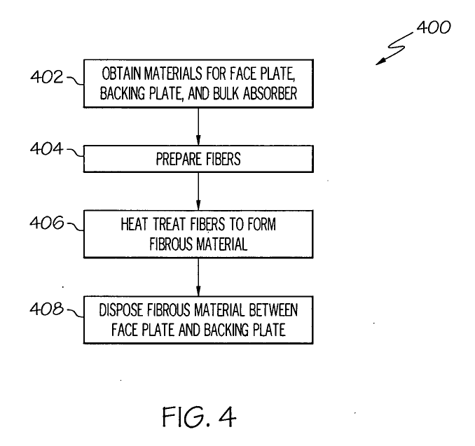

To manufacture a noise suppression panel 100, method 400, an embodiment of which is illustrated in a flow diagram in FIG. 4, may be employed. According to an embodiment, materials suitable for use as a face plate, a backing plate, and a bulk absorber are obtained, step 402. The materials may be selected from any of the materials mentioned above in the description of the face plate 102, backing plate 106, and the bulk absorber 104. For example, as noted above, the bulk absorber may comprise one or more types of glass and/or ceramic materials having the characteristics described above for fibers 200, 201, 300. For example, a suitable amount of fibers 200, 201, 300 including low and high melt components are obtained.

After obtaining appropriate amounts of the desired fibers 200, 201, 300, the fibers may be prepared, step 404. For example, the fibers may be disposed in a container. In another embodiment, the fibers may be blended in a blender to shorten the fibers into desirable lengths. In still another embodiment, the fibers may be compacted to a particular density. In an example, the fiber volume fraction may be in a range of from about 0.015 to about 0.055. In other embodiments, a more or less dense network of fibers may be desired and thus, more compaction or less compaction may occur.

The fibers are heat treated to form a fibrous material, step 406. According to an embodiment, heat treatment is employed to soften or melt the low melt component of the glass or ceramic fiber. As a result, the low melt component of one or more fibers may bond to each other at contact points or may bond to other fibers without either low or high melt components. In an embodiment, heat treatment occurs at a temperature that is substantially equal to the melting point of the low melt component. In another embodiment, heat treatment occurs at a temperature that is above the melting point of the low melt component. In either case, to avoid melting the high melt component or other fiber component that may be present in the plurality of fibers, the heat treatment temperature is below the melting point of the high melt component, and/or the melting point of the other fiber component. The heat treatment temperature may be in a range of from about 500° C. to about 1000° C., in an embodiment. In another embodiment, the heat treatment temperature may be greater or less than the aforementioned range. Heat treatment may occur for a duration of between about 15 min and 4 hours, depending on the heat treatment temperature and melting points of the high and low melt components. After heat treatment, the fibers form an interconnected fibrous material. In an embodiment in which the material is capable of undergoing phase separation into a low and a high melt component, the two components are separated. According to an embodiment, the phase separation may be induced by a temperature profile, the effect of which may be enhanced by use of a flux, such as borate (B₂O₃) and/or lithium borosilicate. In another example, an additional amount of glass or ceramic fibers that include the low melt component, the high melt component, or neither component may be obtained, in an embodiment.

In an embodiment of the method 400, the fibrous material is disposed between the face plate and the backing plate, step 408. For example, the fibrous material may be attached to the backing plate. In an embodiment, the fibrous material may be adhered to the backing plate with an adhesive capable of withstanding temperatures of at least 371° C. and resisting degradation when exposed to fluids, such as fuel, water and hydraulic fluids. Suitable adhesives include, but are not limited to cements, and the like. The adhesive may be applied to either or both the fibrous material or to the backing plate, and the fibrous material and the backing plate may then be brought into contact with each other. In another embodiment, the fibrous material may be fastened to the backing plate with one or more fasteners. In accordance with an embodiment, the fasteners may include one or more screws, bolts, clamps, or other fastening mechanism. Next, the face plate may be placed over the fibrous material so that the fibrous material is disposed between the face plate and the backing plate to thereby form the noise suppression panel. Alternatively, the fibrous material may not be attached to the backing plate, and the fibrous material may be placed between the face plate and the backing plate without fasteners.

By employing the network of glass and/or ceramic fibers described above, a material has been provided that is capable of withstanding temperatures that are greater than 371° C. (700° F.). Moreover, because the network of fibers does not include organic matter, these materials may be employed in many more components in which operating temperatures were previously limited. The fibers may be formed into a fibrous mat for use in applications in which noise reduction or filtration at high temperatures may be desired.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

What is claimed is:

1. A fibrous material, comprising:
a network of a plurality of fibers selected from a group consisting of glass fibers and ceramic fibers, the plurality of fibers including a first fiber and a second fiber, the first fiber having a first low melt component and a first high melt component, the first low melt component of the first fiber having a first melting point, the first high melt component of the first fiber having a second melting point that is higher than the first melting point, wherein
the first low melt component of the first fiber extends alongside and is adjacent to at least a segment of the first high melt component of the first fiber and is bonded to the second fiber at a contact point.

2. The fibrous material of claim 1, wherein the first low melt component of the first fiber and the first high melt component of the first fiber are disposed coaxially.

3. The fibrous material of claim 1, wherein the first low melt component of the first fiber surrounds a circumference of the first high melt component of the first fiber.

4. The fibrous material of claim 1, wherein the first low melt component and the first high melt component are disposed in a side-by-side configuration.

5. The fibrous material of claim 1, wherein the network of the plurality of fibers is compacted to a fiber volume fraction in a range of from about 0.015 to about 0.055.

6. The fibrous material of claim 1, wherein the first fiber comprises a single glass or ceramic material separated into the first low melt component having a first coefficient of thermal expansion and the first high melt component having a second coefficient of thermal expansion that is different from the first coefficient of thermal expansion.

7. The fibrous material of claim 1, wherein the first low melt component comprises a first material and the first high melt component comprises a second material that is different from the first material.

8. The fibrous material of claim 1, wherein the first low melt component comprises a first glass material, and the first high melt component comprises a first ceramic material selected from a group consisting of alumina and zirconia.

9. The fibrous material of claim 1, wherein the first low melt component comprises a first glass material selected from a group consisting of alkali borosilicates, and the first high melt component comprises a second glass material selected from a group consisting of silicates and borosilicates.

10. A noise suppression material comprising:
a face plate;
a backing plate; and
a fibrous mat disposed between the face plate and the backing plate, the fibrous mat comprising a network of a plurality of fibers selected from a group consisting of glass fibers and ceramic fibers, the plurality of fibers including a first fiber and a second fiber, the first fiber having a first low melt component and a first high melt component, the first low melt component of the first fiber having a first melting point, the first high melt component of the first fiber having a second melting point that is higher than the first melting point, wherein
the first low melt component of the first fiber extends alongside and is adjacent to at least a segment of the first high melt component of the first fiber and is bonded to the second fiber at a contact point.

11. The noise suppression material of claim 10, wherein the first low melt component of the first fiber and the first high melt component of the first fiber are disposed coaxially.

12. The noise suppression material of claim 10, wherein the first low melt component and the first high melt component are disposed in a side-by-side configuration.

13. The noise suppression material of claim 10, wherein the network of the plurality of fibers is compacted to a volume fraction in a range of from about 0.015 to about 0.055.

14. The noise suppression material of claim 10, wherein the first fiber comprises a single material separated into the first low melt component with a first coefficient of thermal expansion and the first high melt component with a second coefficient of thermal expansion different from the first coefficient of thermal expansion.

15. The noise suppression material of claim 10, wherein the first low melt component comprises a first material and the first high melt component comprises a second material that is different from the first material.

16. A method of manufacturing a noise suppression material, the method comprising the steps of:
heat treating a plurality of fibers to a first temperature, the plurality of fibers selected from a group consisting of glass fibers and ceramic fibers, the plurality of fibers including a first fiber and a second fiber, the first fiber capable of phase separation at the first temperature into a low melt phase and a high melt phase and bonding to itself or to the second fiber.

17. The method of claim 16, further comprising the step of disposing the network of the plurality of glass fibers between a first panel and a second panel.

18. The method of claim 16, wherein the first fiber comprises a borosilicate.
